(19) United States
(12) Patent Application Publication
(10) Pub. No.: US 2008/0282286 A1
(43) Pub. Date: Nov. 13, 2008

(54) Method and Apparatus for Conducting Real Time Dialogues With Mass Viewer Audiences During Live Programs

(75) Inventor: Amit Or, Mishmeret (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Inlive Interactive Ltd., Ra'anana (IL)

(21) Appl. No.: 11/885,097

(22) PCT Filed: Feb. 27, 2006
(86) PCT No.: PCT/IL06/00262

§ 371 Date: Jul. 10, 2008

(30) Foreign Application Priority Data
Feb. 28, 2005 (IL) 167126

(51) Int. Cl. H04N 7/025; H04N 7/173; H04N 5/445

(52) U.S. Cl. 725/34; 725/60; 725/109

(57) ABSTRACT

Disclosed is a system for conducting real time dialogues with an audience comprising a plurality of remote viewers of a broadcast program, said system comprising: (a) a Real Time Dialog Machine having input ports for enabling substantially simultaneous data input from each of a plurality of viewers in data communicating therewith over at least one data network; (b) a Dialogue Management Console coupled to the Real Time Dialog Machine via a data link, said Dialog Management Console for allowing management of said dialogues by program production personnel; (c) a database of interactive sessions accessible by the dialogue management console and in data communication with the Real Time Dialog Machine via a participation processor for processing aggregated data from the Real Time Dialog Machine, and (d) displaying means for adding derived data and/or visual cues to program for transmission to displays viewable by the viewers.

### FIELD OF THE INVENTION

The present invention is directed to providing an improved method and equipment for interacting with a remote audience and particularly, but not exclusively for conducting real time dialogues with mass viewer audiences during live Programs.

### BACKGROUND

In its first half century, television was largely a passive experience. The main difference between the cinema experience and conventional television, is that going to the cinema was an outing and also a community experience, with a sense of being part of the audience, whereas with television, the viewer watches programs from the comfort of his/her armchair and is only aware of other viewers in his close geographical proximity, that is, people watching the same television set.

As commercial television and cable television spread, and with the spread of remote control units, the viewer had the option to change channels and to view a different program without getting up from his seat. With an ever wider choice of programs available, it was increasingly difficult to hold the viewer's loyalty to a channel, and viewers tended to flick from one channel to another. Despite an ever increasing standard of programming it also proved ever more difficult to hold the attention of the viewer, with concentration spans dropping and fewer viewers actively absorbing the contents of the programs viewed.

Much TV revenue is generated by advertising. However each commercial TV channel competes with other channels and also with other media, such as the Internet, newspapers, radio, billboards etc. for advertising budgets.

To increase ratings, viewer loyalty over time, and to make the viewing experience more active, various techniques have been tried over the years, with varying degrees of success.

For example, competitions and quizzes with generous prizes have always been popular. The viewer at home tries to answer the questions put to the competitor in the TV audience, or at least says to himself that he could do as well, and imagines what he would do with the winnings. However, prizes from TV quizzes have become enormously expensive, and different TV channels have gravitated towards similar formats. Although still an audience draw, the possibility of winning very large sums of money or expensive luxury goods is no longer the audience attraction it once was, since it has all been done before.

To maintain viewer loyalty and to improve the interactive experience, the quiz host usually asks one or more questions to the viewer at home. When first introduced, back in the days when there was only a handful of channels, the viewer was invited to send his answer on the back of a self-addressed postcard, so that one or more correct answers would be drawn out of a drum the following week, to get some trivial prize. Nowadays, the number of responses generated by such a tactic would be painfully low, and this ploy would do little to ensure that the viewer would tune in the following week.

Where shows were broadcast live, having telephone lines available for the home viewer to phone in his answer to some question was another technique that had some success. The problem with the technique is that a large number of operators were needed, callers were placed on hold indefinitely and switchboards were jammed. With Interactive Voice Response (IVR), this problem was somewhat eased as the voting process is relatively short, allowing a large number of viewers to participate. However, IVR is not synchronized with the action on the television screen, and, since the people do not vote at the same time, neither the viewer nor the presenter can see the cumulative response as it happens, in real time. Another problem with IVR is that it is inappropriate for more sophisticated interactive contents consisting of more than one question especially if later questions are based on and follow on from earlier questions creating a dialog since few viewers can be expected to call up more than once, and, with IVR, as sessions include more queries, the number of participants drops off accordingly.

Another problem with IVR based interactive applications is that they require to be constructed by the IVR provider in advance and the flow of a show as well as the questions and answers require to be defined exactly before the show

A further development that went some way to addressing this issue was the availability of Short Message Service, or SMS. Here, the viewer could use his mobile phone to send an answer to the TV channel, to vote for a competitor in a competition, or to otherwise participate. Some minutes later, the results could be collated, enabling the presenter to react to participation of home viewers in a small period of time, such as later on in the program, or after a commercial break. Another technique that enabled large numbers of participants to respond and to have their responses reacted to in a short period was via the Internet.

Also, of some utility, is the handset of digital cable television, having a so-called red button, allowing limited interaction with the program viewed thereby. There has been much activity directed to improving the degree of audience participation offered to home viewers of TV shows. The aim has been to allow an ever larger number of viewers to interact in ever more complicated ways with a live TV program to trigger a response in a short period of time.

Co-pending application number WO05050969 to the inventor of this application, entitled “Mass Viewer Audience Circuit Based Real Time Participation In Interactive Applications Displayed Live On Display Screens” is directed toward mass viewer audience circuit based real time participation in live TV shows, and other interactive applications displayed on electronic billboards, so-called videowalls, and the like. The technology described therein includes a Mass Viewer Audience Response Detection (MVARD) gateway (14) for establishing inbound half duplex line connections with callers' telephones on receiving circuit based telephone calls therefrom for determining callers' DTMF key depressions corresponding to their real time responses to an interactive application, and transmitting real time information regarding the callers' responses for providing real time feedback to the mass viewer audience watching the interactive application, and particularly the callers continuously holding their telephones like a hand held TV remote control and depressing on the DTMF keys on their telephones to input their responses to actively participate therein without interrupting their participation to listen to pre-recorded playback messages regarding DTMF key assignments. This application relates to talk shows and the like.

U.S. Pat. No. 6,443,840 to Von Kohom, entitled “Game conducting system for players at remote location” relates to the evaluation of responses of a participatory broadcast audience with prediction of winning contestants; monitoring, checking and controlling of wagering, and automatic crediting and couponing. A system and method for evaluating responses to broadcast programs, such as television programs is provided. The system includes an instructional signal modulated onto a signal transmitted concurrently with the television program, simulcast, or time-multiplexed with a television. At each of a plurality of remote receiving stations, one or more members of a remote audience has the opportunity to respond to a situation presented in the television program by entering a response on a keyboard. The system described therein, includes response evaluation circuitry which may be located at a central facility or partially at the central facility and partially at each remote receiving station, or completely within a response unit at each remote receiving station, in the latter case the response unit has a memory responsive to the instructional signal for storing acceptable responses, a comparison circuit for comparing responses entered at the keyboard with those stored in the memory, circuitry for scoring responses in accordance with commands from the instructional signal, and a recording device for providing a permanent record of the audience score at the remote station. For conducting a sweepstakes, numbers or other responses are entered at the remote stations and are stored at a central facility for verification. The program may be presented live, and conducted by a host at a central station, or by a prerecorded message accessible by telephone from a remote station with regulation from a central station, and members of the remote audience may predict or select winning contestants.

The Von Kohort patent illustrates the problem with prior art systems in general, in that to give the illusion of wide audience participation, a small number of remote viewers are enabled to participate in a program. The remote participants are, at best, a representative sample of the TV audience. Allowing active participation of all viewers is clearly the aim, but the technology available falls short of that required.

United States Publication Number US20010049625 to Mowry, entitled “Method and system for eliciting consumer data by programming content within various media venues to function cooperatively” relates to an interactive, network based marketing method that involves promoting products and services according to marketing data obtained from a web site user participating in a game provided by the web site.

Specifically, Mowry's technology is directed to a multimedia system and method which includes a television program, an electronic commerce catalog, an interactive Internet site and an electronic communications network linking the television program, the electronic commerce catalog and the interactive Internet site. The system and method is designed such that the users of the Internet site affect the content within the live television program, and the live television program is produced to function in tandem with the Internet site such that the content of the program determines the content of the electronic commerce catalog.

In Mowry's technology, the TV program reports and reflects the activities taking place at the Website. Web-traffic is not trully real time. The viewers are not able to influence the TV program in any meaningful way.

Published PCT Application Number WO05079483A2 entitled “Methods And Computer Program For Multimedia Interaction” describes yet another attempt to increase remote user participation in a game show to enhance the feeling of involvement and to boost ratings. The publication relates to a Multimedia interaction method in a live game show that involves selecting one participant from several viewers and transmitting digital information having both image and audio contents between participant and broadcaster.

European Patent Number EP0804856, entitled “Interactive Television”, enables viewers to take part in a television quiz show with studio participants—allowing viewers to participate independently in first part of quiz and then connecting those with sufficiently high score to the studio so as to answer questions in real time. Here the interaction is by the colour coded buttons on the remote controller of the TV.

Published PCT Application Number WO0139506 entitled “System and Method for Synchronizing Online Activities with Broadcast Programming” describes a system that allows large numbers of users to engage in on-line, multi-user shows that are synchronized to broadcasts of prerecorded or live shows and also simultaneously aggregates user input from such shows and feeds it back into the broadcast.

In the technology described, a user first launches a client application on an Internet-accessible platform. The client application connects to a multi-user server system. This multi-user server system allows all of the concurrent users to engage in a single multi-user, on-line activity that can run independently or in synchronization with a broadcast. The multi-user server system is also capable of running numerous on-line activities simultaneously, each of which can be synchronized to a separate broadcast. As the users interact Keith the on-line activities, the multi-user server system can aggregate data relating to the users or their actions, save this data in a database, and feed this back into the broadcast. The multi-user server system also includes the ability to send messages to all the users or specific groups of users, adjust the synchronization of the on-line shows, schedule on-line shows, and create scripts for running the shows in synchronization with the broadcasts.

U.S. Pat. No. 6,018,768 entitled “Enhanced video programming system and method for incorporating and displaying retrieved integrated internet information segments” relates to an interfacing system for combining television broadcast and Internet in education and entertainment applications.

Specifically, a system for integrating video programming with the vast information resources of the Internet is described. A computer-based system receives a video program with embedded uniform resource locators (URLs). The URLs, the effective addresses of locations or Web sites on the Internet, are interpreted by the system and direct the system to the Web site locations to retrieve related Web pages. Upon receipt of the Web pages by the system, the Web pages are synchronized to the video content for display. The video program signal can be displayed on a video window on a conventional personal computer screen. The actual retrieved Web pages are time stamped to also be displayed, on another portion of the display screen, when predetermined related video content is displayed in the video window. As an alternative, the computer-based system receives the URLs directly through an Internet connection, at times specified by TV broadcasters in advance. The system interprets the URLs and retrieves the appropriate Web pages. The Web pages are synchronized to the video content for display in conjunction with a television program being broadcast to the user at that time. This alternative system allows the URLs to be entered for live transmission to the user.

Published PCT Application Number WO0113632 entitled “Internet-Based Program Broadcast System” relates to an Internet-based program broadcast system having repeater-aggregators which receive, aggregate and output feedback information to a broadcaster through a communication pipe, thereby providing a decentralized network for the high-quality transmission or live or prerecorded interactive Internet-based programs such as shows, classes, and meetings to a virtually unlimited number of clients any place in the world.

There is thus a long-felt need to provide a system or technology platform to allow fuller continuous participation of the remote viewing audience of a TV program with the program. The prior art offers a number of partial solutions, that, in general, give the illusion of participation to a greater or lesser degree, but fall short to trully allowing a large sector of the remote audience to actively participate, to influence the direction of a current affairs debate, for example, to participate in quizzes and the like. The present invention addresses these issues.

### SUMMARY OF THE INVENTION

It is an aim of the invention to provide a system, typically comprising software on an appropriate hardware platform, for allowing the director of a program to orchestrate the participation of a large, remote audience with a live program, to influence the interactivity work flow and the program in real time.

It is a further aim of the invention to provide a means and methodology for enabling a remote audience to participate in a program, extensively, with their participation effecting the program in real time.

In a first aspect, the present invention is directed to providing a system for conducting real time dialogues with an audience comprising a plurality of remote viewers of a broadcast program, the system comprising:
(a) a Real Time Dialog Machine having input ports for enabling substantially simultaneous data input from each of a plurality of viewers in data communication therewith over at least one data network;
(b) a Dialogue Management Console coupled to the Real Time Dialog Machine via a data link, said Dialog Management Console for allowing management of said dialogues by program production personnel;
(c) a database of interactive sessions accessible by the dialogue management console and in data communication with the Real Time Dialog Machine via a participation processor for processing aggregated data from the Real Time Dialog Machine, and
(d) a displaying means for adding derived data and/or visual cues to the program for transmission to displays viewable by the viewers.

In preferred embodiments, the Real Time Dialog Machine allows simultaneous input from a plurality of viewers on a continuous basis.

Preferably, the Real Time Dialog Machine allows individualized output to each interacting viewer based on individual history.

Optionally and preferably, the Dialog Management Console allows management of said dialogues by the program production personnel in an ad hoc manner throughout the program.

Preferably, the Dialog Management Console allows management of said dialogues by said program production personnel continuously, in real time.

In preferred embodiments, the system of claim 1 wherein the Dialog Management Console allows the program production personnel full control of options offered to individual viewers, including ability to disconnect specific, individual viewers, based on criteria selectable via the Dialog Management Console.

In various embodiments of the system, the data input may be inputted via at least one device selected from the list of: (i) a remote control unit of a television; (ii) a keyboard or mouse of a computer, where said display is a webpage on a computer network accessible via said at least one data network and displayable on visual display unit of said computer; (iii) a keypad of a portable telecommunication device such as a cellular phone, a palm top computer or a laptop computer; (iv) a keypad of a telephone, and (v) a control unit of a dedicated hardware coupled to the display, such as via a remote control interacting with a set-top box in a digital cables scenario.

The at least one data network comprises at least one network selected from the list of cellular telephony networks, PSTN networks, Internet, private IP networks and digital cable networks.

The dialogue may comprise a survey, in which case the inputs comprise response to the survey and the display comprises results of the survey.

Additionally or alternatively, the dialogue may comprise a quiz, the inputs may comprise responses to questions of the quiz and the display may comprise questions and answers of the quiz.

Alternatively again, the dialogue may comprise an interactive game, the inputs may comprise moves in the game and the display may comprise effects of the moves.

The displays are selectable from the list of television screens, screens of mobile telecommunication devices, computer monitors and projected displays.

Typically the audience that is able to participate in real time dialogue comprises thousands of viewers. However the audience able to participate in real time dialogue may comprise tens of thousands of viewers, and in some embodiments, perhaps hundreds of thousands of viewers.

The Dialogue Management Console typically comprises appropriate software supported by a computer.

The displaying means is typically an overlay overlayable onto the program.

Alternatively, the displaying means is a box displayable on the display and viewable by said viewer.

In a second aspect, the present invention is directed to providing a Dialogue Management Console for allowing program production personnel to manage interactive participation of a plurality of remote viewers with a program; the Dialogue Management Console being couplable via a data link to a Real Time Dialog Machine having input ports for enabling substantially simultaneous data input from each of a plurality of viewers in data communication therewith over at least one data network; the Dialogue Management Console being accessibly couplable via a data link to a database of interactive sessions and being further couplable to a displaying means for adding derived data and/or visual cues to the program for transmission to displays viewable by the viewers.

Typically, the Dialogue Management Console has a user-friendly graphic interface, and may be a Windows type software application supported by a networked computer.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a conceptual block diagram showing the interrelationships of the essential components of the system system for conducting real time dialogues with a plurality of individual viewers in a remote audience;

FIG. 2 is a frame of an exemplary TV program of the present invention, showing how a question may be displayed in part of the frame, with instructions for inputting responses and a visual representation of the total audience and their responses;

FIG. 3 is a frame of another exemplary TV program showing how questions and answers may be overlayed onto a program;

FIG. 4 is a screen capture of the main window of an exemplary dialogue management console, showing the typical Windows type interface, allowing production personnel to simply and conveniently orchestrate and mediate between choices offered to viewers, inputs received from viewers and displayed results from viewers;

FIG. 5 is a close up of one type of display that is displayable to production personnel peripherally to the main window, allowing the production personnel to be aware of audience involvement in real time, and allowing tailoring of interactions offered to the audience;

FIG. 6 is a drop down menu showing some of the typical settings options that may be selected by the production personnel to control the interactivity of viewers;

FIG. 7 is a display field showing a list of shows such that production personnel can manage the interactivity thereby;

FIG. 8 shows a control window in accordance with one embodiment of the invention, the control window for allowing the producer to select preprepared questions from a list of questions in accordance with previous responses from the audience and viewer statistics displayed in the display of FIG. 5;

FIG. 9 is a screen capture of an exemplary list of questions, showing how questions may be composed or edited during a live program, prior to being displayed to the audience, allowing a high level of tailoring of interactive elements to developments within the program and feedback from the audience;

FIG. 10 is an example of the type of window that might open up on selecting a question from the list of either FIG. 8 or 9, showing how a question can be quickly drafted and an appropriate range of answers can be compiled to be offered to the audience, allowing the production personnel to select and designate the correct answer, and to add or delete the question from a particular program session, and to activate the question when deemed appropriate to do so;

FIG. 11 shows how production personnel may manage an activated question by, for example, adding a time limit for response and perhaps displaying a countdown to the audience, choosing when to display the question, when to display answer, when to allow responses and when to move on;

FIGS. 12 and 13 show the type of displays for summarizing the interactions with previously displayed questions to provide feedback to the production personnel.

FIG. 14 is a flow chart showing the stages of authoring a show, and

FIG. 15 is a flow chart showing the stages of activation.

### DESCRIPTION OF THE PREFERRED EMBODIMENTS

The present invention is directed to providing interactive gaming and interactive TV, giving subscribers the ability to use their input device to interact continuously with a TV show or with an interactive game running on a digital screen in a public place. For telephone operators and for cable TV operators, this innovative new service offers solid revenue-enhancing opportunities in both the consumer and corporate market segments. One preferred embodiment is built on a distributed, Telco-grade server architecture. This makes the InLive mass participation service provided thereby readily expandable, since it is easy and economical to add new services to keep up with evolving user needs and marketplace requirements.

Interactive TV and interactive games as facilitated by the present invention enhance and enrich the viewer's TV experience by making him an active participant rather than a passive observer. They also provide new opportunities for both wireless and wire line telecommunication service providers as well as for cable TV service providers since the InLive Mass Participation Solution described hereinbelow provides a new way to deliver innovative chargeable and feature-rich services which translates into increased revenues and new revenue sources including new subscription fees and higher average connect time. The increased enjoyment provided by the interactivity results in higher broadcast ratings.

To quickly deliver this potentially lucrative service with the high quality that customers expect, operators must be able to deploy solutions that are flexible, scalable, and easy to implement in their networks infrastructure. These new services must also be compatible with both Operations Support Systems (OSS) and Business Support Systems (BSS). Other key factors for an operator choosing a solution provider to help meet its technology, business performance, and competitive challenges include the service provider's portfolio, its capacity to adapt the service to specific customer needs, and an understanding of the operator's constraints. Operator margins also depend on the flexibility of the solution provider and its ability to react to the operator's needs. The present invention addresses these issues.

As used herein, the term “Mass Viewer Audience Participation Event” relates to an opportunity for remote viewers of a live show, typically a live TV show, to participate in the show and to affect its content and progress in real time.

Participation is achieved through interactions. A mass viewer audience participation event can take place on a number of different mass viewer audience mediums, for example, a TV show broadcast over the ether or transmitted over a cable network, a web page browsable via a web-browser, such as an internet enabled PC, and the like. Furthermore, in some embodiments, such a mass viewer audience participation event can take place simultaneously on two or more different media.

Conceptually, in this concept, an “Interaction” is a process by which (a) audiences are provided with one or more cues that invite participation, (b) a period of time is allocated during which the participants can reply and during which the visual cues can be modified to include (for example) accumulating results and (c) a closing event at which the cues can be removed and replaced (for example) with a final result after processing all the viewer responses. The means by which viewers may participate depends on the medium in question. For example, viewers watching TV screens, outdoor monitors, and the like would typically call callback telephone numbers in order to participate in a mass viewer audience participation event. Such callback numbers would be called from a mobile phone, or a land line. Viewers surfing the Internet, instead of or in conjunction with watching the program on a TV monitor, can participate by mouse clicks.

Furthermore, it will be appreciated that as time goes on, the distinctions between television, computer and telephone become increasingly blurred. One can watch TV programs over the Internet or even on the screen of a personal computer having a TV card. Internet enabled computers allow telephony using VOIP technology, and mobile phones increasingly allow Internet access and some allow viewing of television channels. Thus any interactive system should allow viewing and participation across platforms, and the term TV or television as used herein relates to an electronic device having a screen and allowing viewing of broadcast or cable transmitted content, the term phone relates to any device having appropriate functionality, and the term computer in this context, is to be understood broadly to include any of a variety of electronic device allowing web browsing. Similarly the term “mouse click” should be understood loosely to include a key depression on a QWERTY keyboard, touching an appropriate area of a touch screen and other computer input devices.

“Interactions” may be grouped together to form longer content units within a show. Such content units may be referred to as “Sessions”. A show might have only one such session, say a vote during, or at the end of a debate, or, perhaps if the show is long, or is built up around mass viewer participation, may include numerous sessions.

Mass Viewer Audience Participation Events are controlled and coordinated as part of the broadcast production process. The control is facilitated by a console through which an operator can control the mass viewer audience participation.

Thus the system proposed and described herein takes complete, two-way ownership of input systems for interacting with a TV program, such as, inter alia, IVR systems, IN- intelligent network, VOIP, IP clients, Set-top box, and the like, and allows production personnel to design and optimize the flow ad hoc, whilst the show is on air. The interactive system may be fully synchronized with the TV program so that every vote of all participants is counted and presented in real time. Indeed the approach described herein has the flexibility to allow viewers to interactively play games such as Packman by sending extensive chains of Dual Tone Multi Frequency (DTMF) signals, one after the other, as the game board changes.

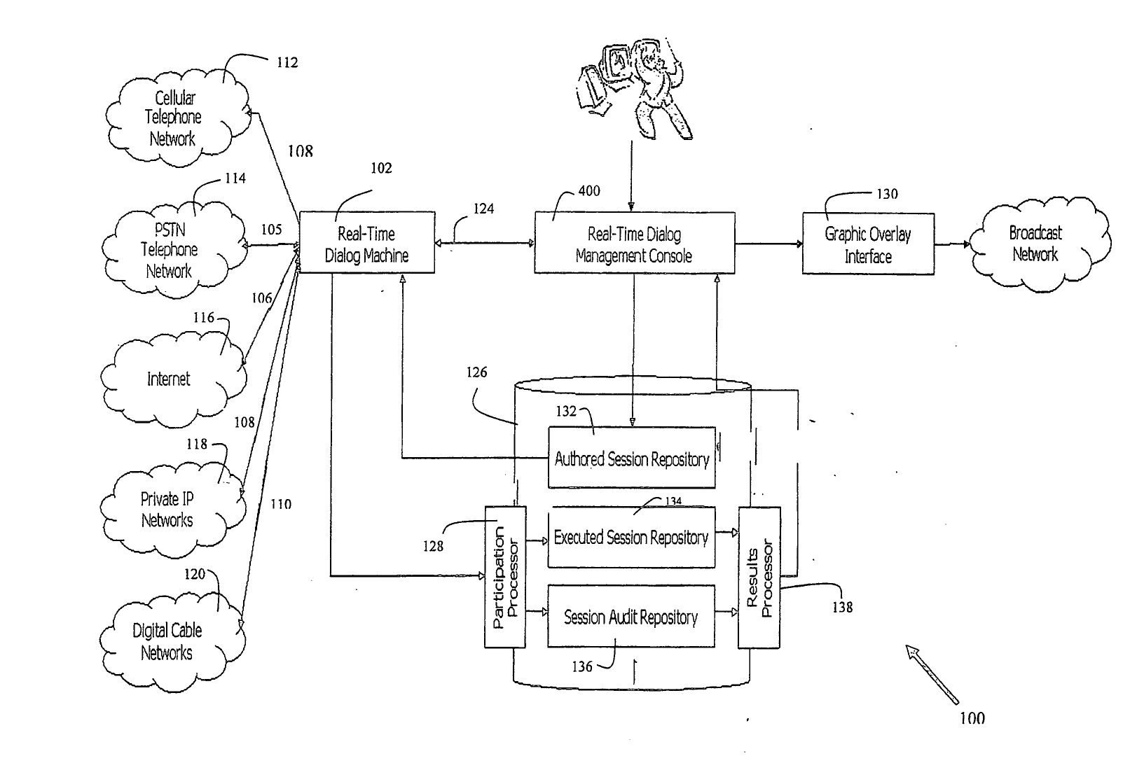

With reference now to FIG. 1, a conceptual block diagram showing the interrelationships of the essential components of the system for conducting real time dialogues with a plurality of individual viewers in a remote audience is shown. The system 100 comprises: a Real Time Dialog Machine 102 through which audience participation signals are collected and processed, having input ports 104, 106, 108, 110, for enabling substantially simultaneous data input from each of a plurality of viewers in data communication therewith over at least one data network, such as cellular telephony networks 112, PSTN networks 114, the Internet 116, private IP networks 118, and digital cable networks 120, for example. The Real Time Dialog Machine 102 may be hosted on one or more computer servers capable of handling extensive communication bandwidth and processing requirements. It will typically include both standard IP interfaces for connecting to Internet and private IP networks and specialized interfaces for connecting to telephony and digital cable networks.

A dialogue management console 400 is provided. Dialogue management console 400 is coupled to the Real Time Dialog Machine 102 via a data link 124, interfacing therewith thereby. Dialogue management console 400 may be a general purpose computer running appropriate software, or a purpose built console having a dedicated keyboard. Dialogue management console 400 allows interactions to be managed by program production personnel, and is in data communication with databases 126 of interactive sessions, thereby allowing the dialogue management console 400 to access data therein. The Real Time Dialog Machine 102 is also coupled to the databases 126 via a participation processor 128 which processes aggregated data from the Real Time Dialog Machine 102. Queries to the remote audience, appropriate responses, statistics representing the number and distribution of responses are fed to a graphical overlay interface 130 which generates and modifies graphic overlay which is added to the broadcast signal to provide participation cues and information to the viewers displayed to the viewers, typically as overlays to the program being viewed. The Graphic Overlay Interface 130 may be purpose built, an example being the proprietary in Live Vizualer of the applicant, or may utilize any of a number of existing graphic rendering solutions commercially available from companies such as VizRT (www.vizrt.com) and Orad (www.orad.co.il), for example. These solutions are used to relay graphical data to viewers across broadcast networks.

Applications for the technology include, for example, a wide range of queries such as quiz questions having correct and incorrect answers, opinion polls on current affairs and the like, and voting for competitors in a competition, which could be a talent show, for example. In this manner, questions, answers and derived data and/or visual cues may be added to programs, particularly live programs, for transmission therewith for display to the viewer on his or her TV set, computer screen or mobile phone display. It is a particular feature of the present invention, that interactive sessions with mass remote viewer participation is effected in real time. The interacting viewer may view the effect of his interaction on the program being viewed, perhaps as it influences the results of a straw poll, or the percentage of viewers answering a question correctly.

The Real-Time Dialog Management Console 400 typically has the following functionality:
Enables an operator to author a show/session on the fly, whilst the shown is on the air
Enables an operator to set parameters for execution of an interaction
Enables an operator to configure how interaction results are to be processed and presented, even on the fly, whilst the show is on air
Relays information to the Graphic Overlay Interface 130 (which relays the dialog on to the audience)
Relays interaction dialog configuration parameters and commands to the Real Time Dialog Machine 102
Collects the dialog results from a Results Processor 138
Provides an operator interacting with the Real-Time Dialog Management Console 400 with reports and analysis tools using the information retrieved from the Results Processor 138

The Real Time Dialog Machine 102 typically has the following functionality:
Receives configuration parameters and commands from a Real-Time Management Console 400
Interfaces with one or more communication networks 112, 114, 116, 118, 120
Collects participation results from the communication networks with which it interfaces
Processes results dynamically based on applications runs on the Real-Time Dialog Management Console 400 and operated in real time by the director
Relays participant activity signals to the Participation Processor 128

The Graphic Overlay Interface 130 can receive signals (commands and information) from the Real Time Dialog Management Console 400 and Real Time Dialog Machine 102 and generates and modifies material as a graphic overlay that is added to the broadcast signal to relay participation information.

The Authored Session Repository 132 if provided, may contain off-line shows/sessions authoring information including, perhaps, a list of Authored Shows, each of which including a list of authored sessions, and including a unique authored show identifier, a show title, producer information, scheduling information, resource allocation parameters, and the like.

The list of Authored Sessions typically includes a unique authored session identifier, session title, a reference to the authored show to which the session belongs, default session configuration parameters. Each authored show will include a list of authored interactions.

The list of Authored Interactions may include a unique authored interaction identifier, a reference to the authored session to which the interaction belongs, the interaction question, a list of possible answers and default participation parameters.

The Executed Session Repository 134 contains information on executed shows/sessions. Such information typically includes a list of Executed Shows that includes: a reference to the authored show, a unique executed show identifier, the date and time the show started, the date and time the show ended, and summary statistics and a list of executed sessions per executed show.

The list of Executed Sessions typically includes a reference to the authored session, a reference to the executed show, a unique executed session identifier, the date and time the session started and the date and time the session ended, summary statistics, session configuration parameters, a list of Executed Interactions and the like.

The list of Executed Interactions, in turn, may include: a reference to the authored interaction, a reference to the executed session, a unique executed interaction identifier, the date and time the interaction started, the date and time the interaction ended, summary statistics and actual executed interaction configuration parameters, for example.

Database 126 typically also includes a list of Participants including a reference to the executed show during which the participant connected, a reference to the executed session during which the participant connected, unique identification codes (IDs) for the participants, participant network identification (such as CallerID for telephone networks), the date and time the participant connected, the duration of time for which the participant was connected and a dynamic profile, the structure thereof being dynamically defined as the session progresses.

Database 126 typically also includes a list of Participant Interactions providing information on the answers each participant relayed for each interaction including an association to the participant who answered, an association to the executed interaction to which the answer relates and the validated answer for each participant to the interaction.

In one embodiment, the database 126 includes a number of repositories, including an authored Session Repository 132, Executed Session Repository 134 and Session Audit Repository 136. These repositories and the Participation Processor 128 and Results Processor 138 will typically be hosted on one or more powerful computer servers capable of storing large quantities of fast-streaming transactions in real-time and providing virtually instantaneous data processing capabilities of the collected data.

Session Audit Repository 136 contains audit information on session activity including: a list of Message Audit of messages between the Real Time Dialog Machine 102, the Real-Time Dialog Management Console 400 and the Graphic Overlay Interface 130.

The participation of a remote viewer can be audited for validity using a list of Participant Activity Audit. If a response is valid, for example if a first participant answer to a multiple choice question that can only be answered once is correct, it will be audited and relayed as valid. Similarly, an invalid response, such as a repeated participant answer to a multiple choice question that can only be answered once, will be audited as invalid, and the information is then relayed.

The Participation Processor 128 can typically accept signals from the Real Time Dialog Machine 102 of participation information, store valid participant answer information in the Executed Session Repository 134 and store all participant relayed information in the Session Audit Repository 136.

The Results Processor 138 typically aggregates and processes information from the Executed Session Repository 134 and the Session Audit Repository 136, formats the information into analysis supportive structures and relays the information to the Real-Time Dialog Management Console 400.

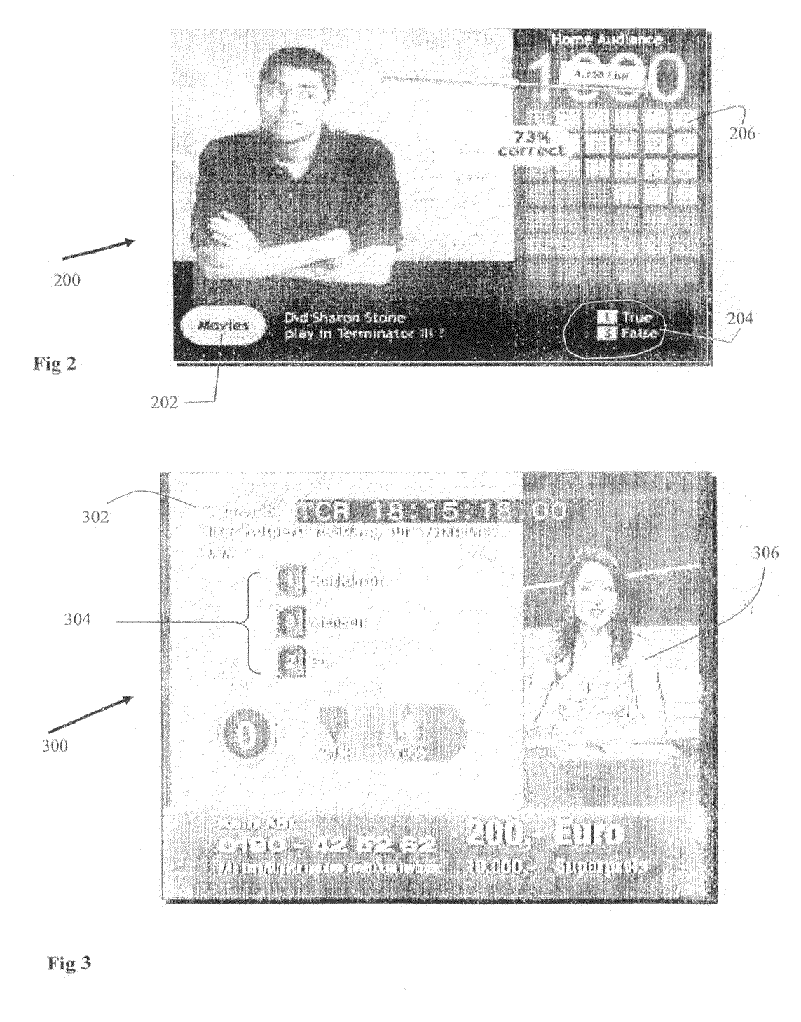

With reference to FIG. 2, a frame 200 of an exemplary TV program utilizing the present invention is shown. The frame 200 illustrates how a question 202 may be displayed in part of the frame 200, such as along the bottom part thereof, together with instructions for inputting responses 204 and a visual representation of the total audience and their responses 206. The interactive elements are typically viewable in conjunction with and not instead of the transmitted image, in this case, the presenter in the TV studio.

With reference to FIG. 3, a second frame 300 from another TV program is shown. Second frame 300 exemplifies how questions 302 and answers 304 may be overlayed onto the activity 306 filmed in the TV studio. In other embodiments, the questions might appear at the edge of the screen, or overlayed on top of the filmed program, which could be horse racing, a sports event, or a current affairs program, for example.

Frames 200, 300 are exemplary screen captures of the picture displayed to viewers on monitoring devices such as television screens, outdoor monitors, wall displays, computer screens, and the like. It will be appreciated, that a virtually unlimited range of alternative scenarios are possible, and the technology is appropriate for trivia and special interest quiz shows, current affairs programs, debates, and the like. Nor is the technology limited to entertainment and education, it could, for example, be used to facilitate rule making by direct democracy, by allowing all interested parties to directly vote on a bill, providing a means of holding a referendum.

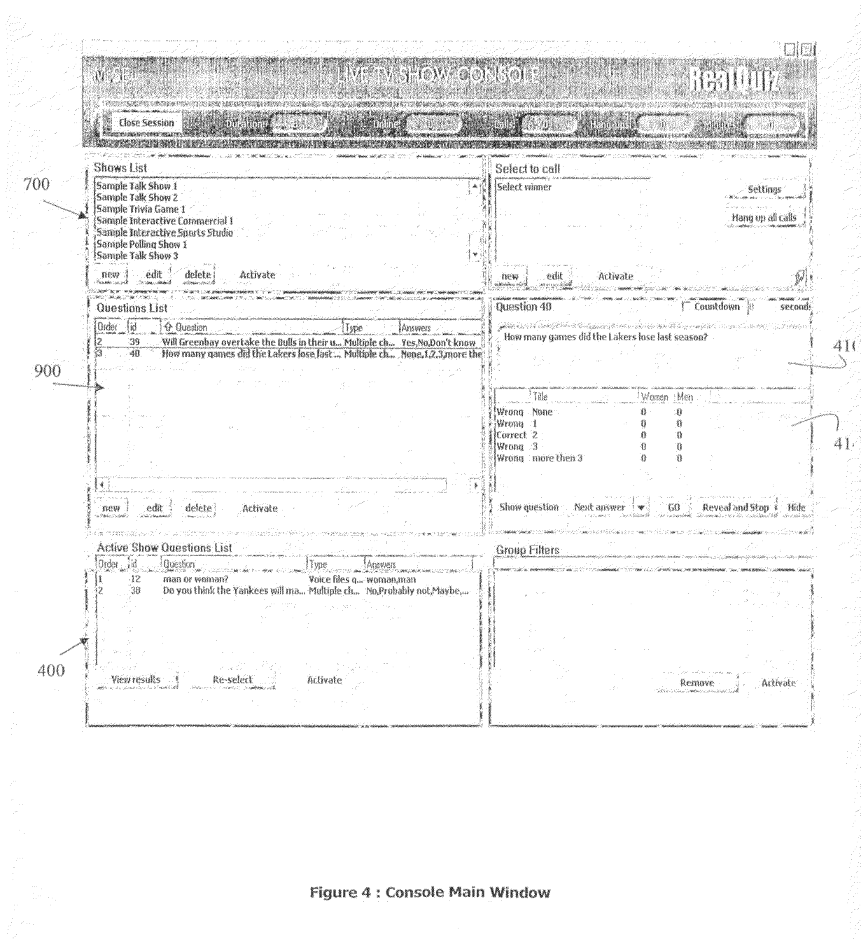

With reference to FIG. 4, a screen capture of the main window of an exemplary dialogue management console 400 is shown in accordance with a working prototype. The screen capture shows a typical graphic interface, allowing production personnel to simply and conveniently orchestrate and mediate between questions offered to viewers 402, types of answers, such as yes/no, multiple choice etc., the range of answers offered 406 inputs received from viewers and displayed results from viewers. The questions offered to viewers 402 may be selected from a list of questions 900 prepared in advance, but each question may be edited in an editing window 410 before being forwarded to the graphic overlay interface 130 (FIG. 1) for subsequent display. The system has inherent flexibility, and the editing window 410 can be used to compose a brand new question. Thus, if for example, a sports game is broadcast and something untoward happens, such as the referee calls foul or the umpire calls lett, the operator interacting with dialogue management console 400 can type up a question in the editing window 410 and forward on to the graphic overlay interface 130 (FIG. 1) for subsequent display. At a horse race, such as the British “Royal Ascot” meet, as well as prepared questions regarding the jockeys, horses, previous winners, etc. the operator can hold a random straw poll comparing hats of spectators, for example. This flexibility provides an intimacy that makes the remote viewer feel part of the action, whether watching his TV from his armschair, viewing the action in a box on his computer monitor whilst ‘working’ in the office, or watching via his mobile phone whilst commuting.

Thus the main screen 400 of the Real-Time Dialog Management Console 400 provides the operator producing the program (as exemplified by, but not limited to programs such as those shown in FIGS. 2 and 3), which is broadcast, transmitted or downloaded to the viewer, with a clear understanding of the current status and the range of actions that may or should be taken in order to progress with the Mass Viewer Audience Participation Event at a tempo and in a manner appropriate to the feedback received from the members of the viewing audience that choose to participate.

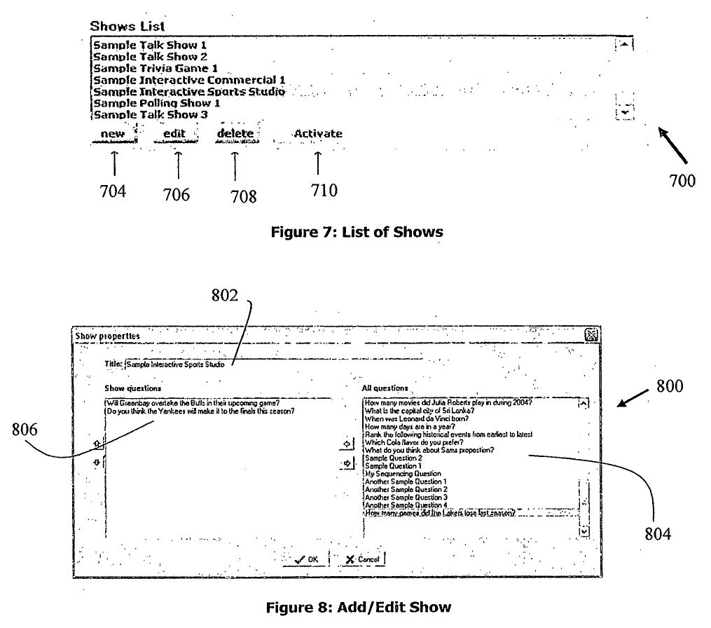

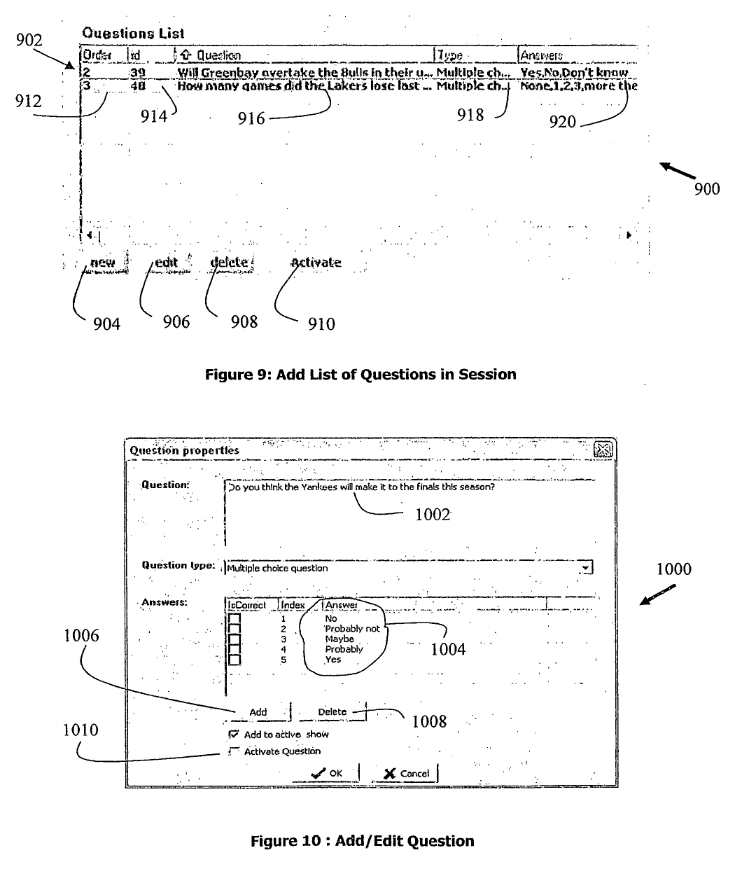

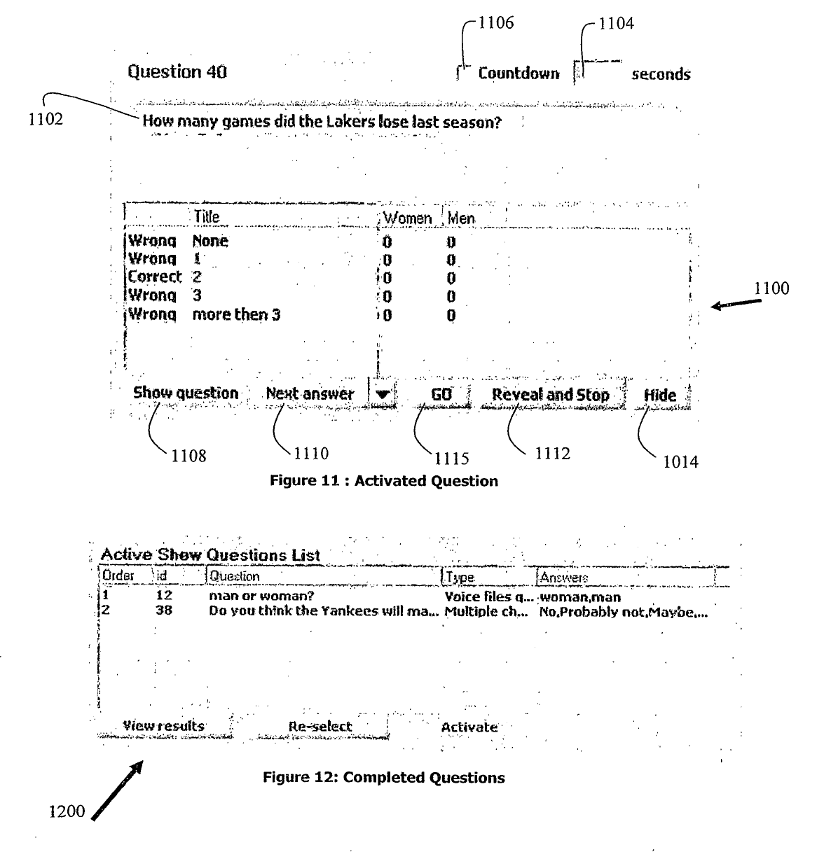

The main screen 400 of the Real-Time Dialog Management Console 400 is divided into fields, typically into boxes, using the familiar Windows type interface. It includes controls and indicators for displaying and managing a Console Status Information Bar 500, as described hereinbelow with reference to FIG. 5, for Session Configuration 412, a list of Sessions/Shows 700 as described hereinbelow with reference to FIG. 7, a list of Questions in Session 900 as described hereinbelow with reference to FIG. 9, Displayed Question & Answers thereto as described hereinbelow with reference to FIG. 11. Completed questions will typically be listed and displayed to the operator in an Active Show Questions List as described hereinbelow with reference to FIG. 12. A result filtering window 414, preferably having a convenient graphics interface is also included. This enables the operator to process responses statistically in terms of various parameters, such as sex, age, income bracket, geographical location, politics, ethnicity, religion, etc., typically based on responses to previous questions, in the present or in previous sessions.

The Real-Time Dialog Management Console 400 thus enables the operator to plan, build and control the progress of a session or show. It enables the operator to either select from a collection of existing interactions, typically from a shows list 700, or to author new interactions, ad-hoc, and to relay them onwards to be transmitted as a graphic overlay together with the program footage, using graphical overlay interface 130 as described hereinabove (FIG. 1). The Real-Time Dialog Management Console 400 relays configuration commands (start session, collect replies, etc.) to the Real Time Dialog Machine (FIG. 1), instructing it as to when to expect and how to process replies from the viewers.

The Real-Time Dialog Management Console 400 receives real-time results from the Real Time Dialog Machine 102 (FIG. 1) and enables the operator to both preview the results and/or to route them to the broadcast by updating the Broadcast Graphic Overlay via the Graphic Overlay Interface 130. It also enables the operator to parse the results using the group filters 414, based on information gathered from previous interactions such as responses 406 to questions 402, for example.

Preferred embodiments of The Real-Time Dialog Management Console 400 include reports for analyzing both sessions and multi-session activity.

With reference to FIG. 5, Session Status Information may be managed via exemplary Console Status Information Bar 500, which is one type of display that is conveniently displayable to production personnel peripherally to the main window of Real-Time Dialog Management Console 400 (FIG. 4), allowing the production personnel to be aware of audience involvement in real time, and allowing tailoring of interactions offered to the audience. Essentially, the controls and content of Console Status Information Bar 500 enable the operator to view, at-a-glance, the status of the current session and to start or end a session.

Allowable operator activity with the Console Status Information Bar 500 will typically be limited to toggling a Start Session/End Session Button 502 ON and OFF, thereby notifying the Real Time Dialog Machine 102 of session start and session end. Optionally the Start Session/End Session Button 502 will also notify the Broadcast Graphic Overlay Interface 400 to activate the initial graphic overlay to be added to the broadcast program by the Graphic Overlay Interface 130 (FIG. 1), typically displaying customized graphic content and a phone number for viewers to call in order to participate. Finally, toggling the Start Session/End Session Button 502 will affect the System Activity, and update the active and executed show sessions, and perhaps trigger a Message audit.

Typically information provided to the operator on the Console Status Information Bar 500 will include, for example, Session duration 504, a realtime report of the number of callers actively online 506, the total number of calls made during the session 508, the totalized number of hang-ups 510 and the number of accumulated call-minutes 512.

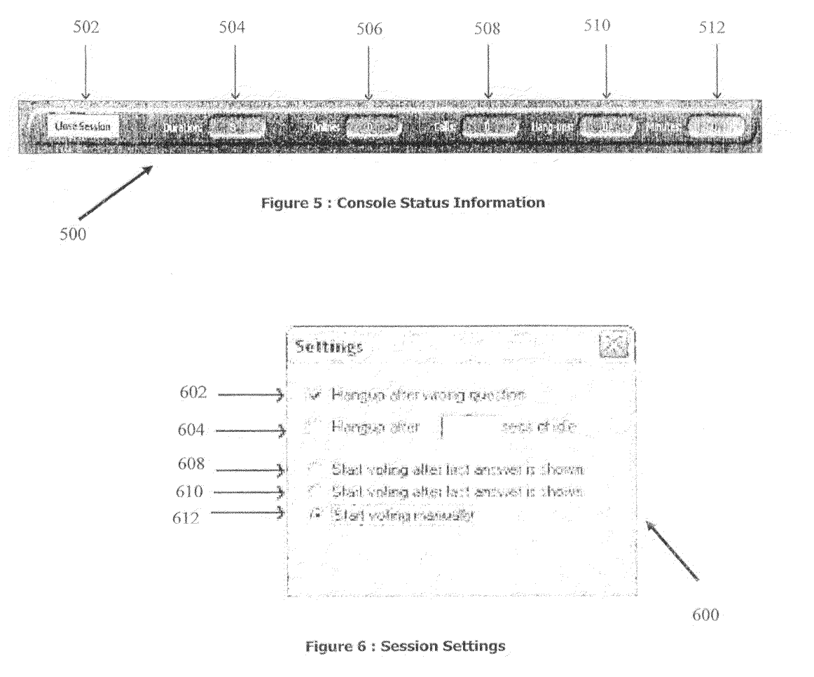

With reference to FIG. 6, a drop down menu 600 is shown, displaying the typical settings options that may be selected by the production personnel to control the interactivity of viewers with the interactive program transmitted.

Drop down menu 600 is triggered from Session Configuration Pane 412. Drop down menu 600 enables the operator to configure interactive parameters within the session. It provides information such as the current state of the current session parameters. The operator can interact with Drop down menu 600 by selecting “Hang-up after wrong answer” 602, by enabling this parameter the operator can set the system to automatically disconnect any and all callers who answer the question incorrectly, thereby enabling a knock out, “sudden death” type quiz with the entire remote viewing audience interested in participating. It will be appreciated that such a possibility provides mass audience participation in quiz shows in a way never before envisaged, and is well beyond anything previously attainable.

The “Hang-up after idle time” checkbox 604 together with field 606 enables the operator to set the idle time to hang-up. In this manner the operator can instruct the system to automatically disconnect callers who have been idle for more than the allowable period of time.

The timing may be controlled in a number of ways. For example, optional Timer Operation Modes include starting the timer automatically after the first answer is displayed 608, starting the timer after the last, i.e. after all answers are displayed 610, or to give added flexibility, the timer can be set to be started manually by checking the manual checkbox 612; in which case the starting will be triggered by using the GO button 1115 as shown in FIG. 11.

Once an appropriate selection is made, the Real Time Dialog Machine 102 (FIG. 1) is alerted regarding the session configuration parameter settings selected, and the Executed Sessions Fields are updated, and a Message audit is prepared.

As described hereinabove, a Session, in the context of the invention, is made up of a series of interactions, typically questions or poll surveys that are offered to the audience of viewers. The questions may be written in advance, or written ad-hoc during the course of the program, to take into account developments, particularly unforeseen occurrences. The dialogue management console 400 can be used on-line, in real-time, during the transmission of the show, or may be configured off-line, in advance. When used off-line the operator can author the questions 402 to be presented and arrange them into “Shows” (sessions) as tabulated in Pane 700 (see FIG. 7). List of Shows Pane 700 displays the list of authored shows 702 and, with the use of additional screen depicted in FIG. 8, enables the operator to create new shows, to edit or delete existing shows or, when used in real time during the broadcast, to activate an existing show.

Referring to FIG. 7, the operator is able to edit a show by interacting with the List of Shows Pane 700, by selecting Edit Button 706 for example. This selection causes a further window 800 as shown in FIG. 8 to be opened, in which the operator can input an appropriate show-name in title box 802, and can select pre-existing questions from a list 804 and add same to the show by moving to a show content pane 806, and thereby set the sequence of questions thereof.

The operator may also create a new show by selecting new button 704. This opens the same window 800 as shown in FIG. 8, but this time, for the purposes of adding a show.

FIG. 8 shows a control window 800 in accordance with one embodiment of the invention. The control window 800 allows the producer to select preprepared questions from a list of questions in accordance with previous responses from the audience and viewer statistics displayed in the display of FIG. 5. In window 800, the operator can perform a number of tasks, including renaming or editing the title of the show in the title bar 802, adding questions to the show from the list of existing questions 804 and/or removing questions assigned to the show.

List of Shows Pane 700 also includes a Delete button 708, allowing the deletion of a show, and an activation button 710 that allows a show to be activated, which, in turn, activates and affects the List of Questions 806 in Session.

Interactions with List of Shows Pane 700 and window 800 result in the Real Time Dialog Machine 102 being notified of a new show, a modified show, a deleted show or an activated show.

With reference now to FIG. 9, a screen capture of an exemplary list of questions pane 900 is shown, illustrating how questions may be composed or edited during a live program, prior to being displayed to the audience, allowing a high level of tailoring of interactive elements to developments within the program and feedback from the audience. When a session is selected and activated, list of questions pane 900 displays the questions 902 associated therewith. The questions 902 are displayed in the sequence in which they were planned. The operator can view the list of questions 902, add new questions by selecting new button 904, edit and delete existing questions using edit 906 and selete 908 buttons, and, when a session is open, activate a question 410 (FIG. 4) using activate button 910 for relay to the broadcast graphic overlay interface 130.

For each question, the following information may be provided: its place in the show sequence 912, a unique question code 914, Question content 916, Type of question 918 and Optional answers 920. The system can support a variety of types of interactions (questions) 902, such as multiple choice questions, which are useful for conducting surveys, voting or opinion polls, multiple choice questions with one correct answer which are useful for applications such as trivia questions, Audience Sequence Questions, which are useful for applications such as advanced trivia questions in which participants are asked to sort a number of items, perhaps ordering historical events, for example. Another type of format, that is useful for competitions, is Head to Head Sequence Questions. These may be used for applications such as two trivia finalists competing in advanced sorting questions, for example.

FIG. 10 is a screen capture exemplifying the type of window 1000 that might open up on selecting a question from the list 806, 902 of either FIG. 8 or 9, showing how a question 1002 can be quickly drafted and an appropriate range of answers 1004 can be compiled to be offered to the audience, allowing the production personnel to select and designate the correct answer, and to add 1006 or delete 1008 the question 1002 from a particular program session, and to activate 1010 the question when deemed appropriate to do so.

When a question 1002 is activated 1010 it is displayed in pane 1100 shown in FIG. 11, which shows how an operator (production personnel) may manage an activated question 1102 by, for example, adding a time limit 1104 for response and perhaps displaying a countdown 1106 to the audience; choosing when 1108 to display the question 1102, when to display answer 1110, when to allow responses and when to move on 1112 to the next question. Thus the operator can apply a timer to the question 1102 and then relay the question 1112 to the Broadcast Graphic Overlay Interface 130. The operator can control the question 1112 both before it is revealed to the viewers and while it is revealed and active. Once the question is revealed 1108 the operator can control the interaction by displaying the possible answers 1110, activating the timer 1106 (where applicable), reveal the correct answer 1112 and finally hide the question 1102 from the viewers, by removing it from the broadcast graphic overlay.

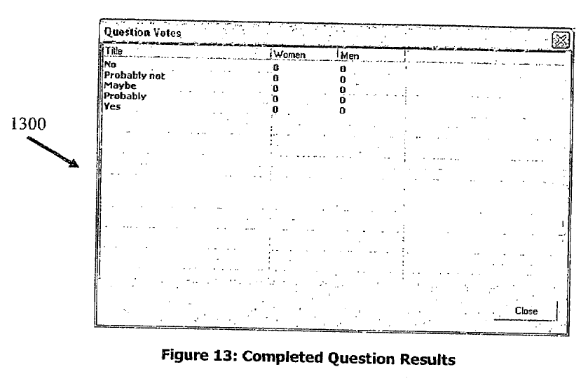

FIGS. 12 and 13 show the type of displays 1200, 1300 for summarizing the interactions with previously displayed questions, to provide feedback to the production personnel.

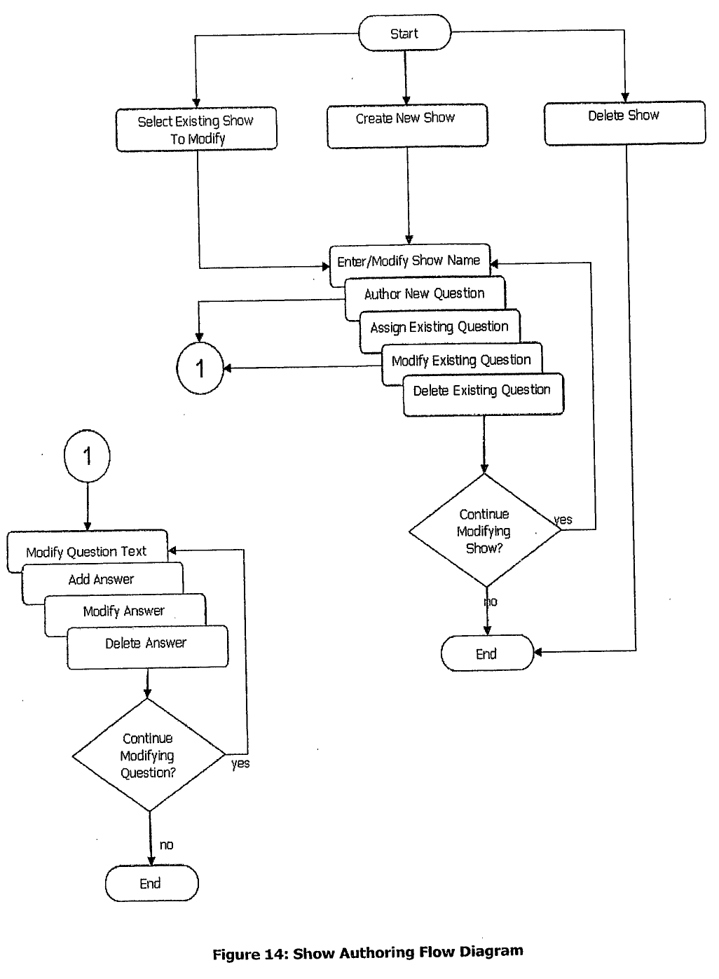

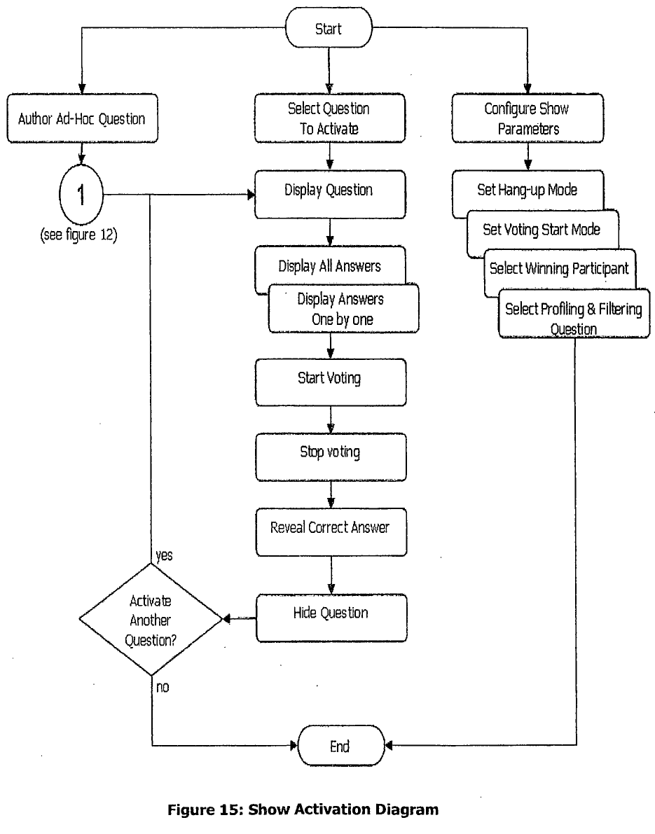

FIG. 14 is a flow chart showing the typical stages of authoring a show, and FIG. 15 is a flow chart showing the typical stages of activation.

The current best mode InLive Mass Participation Solution is based on modular communications technologies. It offers mobile service providers and content providers the opportunity to attract new customers, reduce chum, and increase revenue. Service providers are able to satisfy market demand for leading edge services and applications, regardless of a user's handset, TV providers are able to raise their rating and satisfy their audience with new interactive TV services and public locations can enjoy a profitable, new entertainment environment.

Because of its distributed architecture, the InLive MPS brings also new types of services to multiple and various market types where the interactive experience has hitherto been unobtainable.

The InLive ISI, IN based solution enables mass call services based on existing network capabilities, with limited hardware investments. Enabling the services to be deployed without addition of circuits and intelligent peripherals resources and providing a low cost solution, faster deployment of new services and a faster return on investment.

The InLive Mass Participation Solution described hereinabove is a modular approach that in addition to TV shows of the types described above, allows the building and servicing of interactive games. Such games can eventually be broadcasted on a TV channel and combined with a TV host or could be projected onto large displays in a public place such as a shopping mall or a sport stadium. The viewing public may join the game and interact directly therewith via their wireless or wire line telephone sets. The players live the experience of seeing their interaction affecting the program viewed on screen in real-time.

In the claims, the term comprise, and variations thereof, such as comprising and the like, imply that the listed components or method steps are included, but not generally to the exclusion of other components or steps.

1. A system for conducting real time dialogues with an audience comprising a plurality of remote viewers of a broadcast program, said system comprising:
(a) a Real Time Dialog Machine having input ports for enabling substantially simultaneous data input from each of a plurality of viewers in data communication therewith over at least one data network; (b) a Dialogue Management Console coupled to the Real Time Dialog Machine via a data link, said Dialog Management Console for allowing management of said dialogues (by program production personnel;
(c) a database of interactive sessions accessible by the dialogue management console and in data communication with the Real Time Dialog Machine via a participation processor for processing aggregated data from the Real Time Dialog Machine, and
(d) displaying means for adding derived data and/or visual cues to program for transmission to displays viewable by the viewers.

2. The system of claim 1 wherein the Real Time Dialog Machine allows simultaneous input from a plurality of viewers on a continuous basis.

3. The system of claim 1 wherein the Real Time Dialog Machine allows individualized output to each interacting viewer based on individual history.

4. The system of claim 1, wherein the Dialog Management Console allows management of said dialogues by said program production personnel in an ad hoc manner throughout the program.

5. The system of claim 1 wherein the Dialog Management Console allows management of said dialogues by said program production personnel continuously, in real time.

6. The system of claim 1 wherein the Dialog Management Console allows the program production personnel full control of options offered to individual viewers, including ability to disconnect specific, individual viewers, based on criteria selectable via the Dialog Management Console.

7. The system of claim 1 wherein said data input is inputted via a device selected from the list of:
(i) a remote control unit of a television;
(ii) a keyboard or mouse of a computer, where said display is a webpage on a computer network accessible via said at least one data network and displayable on visual display unit of said computer;
(iii) a keypad of a portable telecommunication device such as a cellular phone, a palm top computer or a laptop computer;
(iv) a keypad of a telephone;
(v) a control unit of a dedicated hardware coupled to the display.

8. The system of claim 1 wherein said at least one data network comprises at least one network selected from the list of cellular telephony networks, PSTN networks, Internet, private IP networks and digital cable networks.

9. The system of claim 1 wherein said dialogue comprises a survey, said inputs comprise response to said survey, said display comprises results of said survey.

10. The system of claim 1 wherein said dialogue comprises a quiz, said inputs comprise responses to questions of said quiz and said display comprises questions and answers of said quiz.

11. The system of claim 1 wherein said dialogue comprises an interactive game, said inputs comprise moves in said game and said display comprises effects of said moves.

12. The system of claim 1 wherein said display comprises displays selected from the list of television sets, screens of mobile telecommunication devices, computer monitors and projected displays.

13. The system of claim 1 wherein said audience able to participate in real time dialogue comprises thousands of viewers.

14. The system of claim 1 wherein said audience able to participate in real time dialogue comprises tens of thousands of viewers.

15. The system of claim 1 wherein said audience able to participate in real time dialogue comprises hundreds of thousands of viewers.

16. The system of claim 1 wherein said dialogue management console comprises appropriate software supported by a computer.

17. The system of claim 1 wherein said displaying means is an overlay overlayable onto the program.

18. The system of claim 17 wherein said displaying means is a digitally generated overlay overlayable onto in-studio activity component of the program.

19. The system of claim 1 wherein said displaying means is a box displayable on display viewable by said viewer.

20. A Dialogue Management Console for allowing program production personnel to manage interactive participation of a plurality of remote viewers with a program; the Dialogue Management Console being couplable via a data link to a Real Time Dialog Machine having input ports for enabling substantially simultaneous data input from each of a plurality of viewers in data communication therewith over at least one data network; the Dialogue Management Console being accessibly couplable via a data link to a database of interactive sessions and being further couplable to a displaying means for adding derived data and/or visual cues to program for transmission to displays viewable by the viewers.

21. The Dialogue Management Console of claim 14 being a windows type software application supported by a networked computer.
